(19) United States
(12) Patent Application Publication
(10) Pub. No.: US 2026/0141200 A1
(43) Pub. Date: May 21, 2026

(54) Apparatus and Method for Encoding RFID Tags

(71) Applicant: GRAPHIMECC GROUP S.R.L, Verona (IT)

(72) Inventors: Andrea Ranzato Vianello, Verona (IT); Vincenzo Roncolato, Verona (IT)

(21) Appl. No.: 19/118,677

(22) PCT Filed: Oct. 6, 2023
(86) PCT No.: PCT/IB2023/060034

§ 371 Date: Apr. 4, 2025

(30) Foreign Application Priority Data
Oct. 6, 2022 (IT) 102022000020583

(51) Int. Cl. G06K 13/073; G06K 7/10; G06K 19/077

(52) U.S. Cl. CPC G06K 13/073; G06K 7/10297; G06K 19/07718

(57) ABSTRACT

An apparatus for encoding RFID tags includes at least one encoding device, for the transmission of signals from and/or to RFID labels carried by a belt slidable in a travel direction; primary drivers, for pulling the belt giving it a continuous forward motion at constant speed; and secondary drivers, suitable for locally varying the speed of the belt when an RFID tag is in the proximity of a transmission area, in such a way that said RFID tag stops for a predetermined time within said transmission area in absence of relative motion with respect to said encoding device.

### CROSS-REFERENCE TO RELATED APPLICATIONS

This application is a U.S. national stage application of International Application No. PCT/IB2023/060034, filed Oct. 6, 2023, which claims priority to Italian Patent application No. 102022000020583, filed Oct. 6, 2022, both of which are incorporated by reference in their entirety into this application.

### TECHNICAL FIELD

This invention relates, in general, to the RFID technology sector; in particular, the invention relates to an apparatus for encoding RFID tags.

### SUMMARY OF THE INVENTION

Known are electronic devices called tags that are equipped with (RFID) radio identification technology.

These are typically devices comprising an electronic chip containing a non-volatile memory and a transmitter circuit acting as a radio frequency antenna, supported by a substrate.

By way of non-limiting example, tags may be configured as adhesive labels, paper strips (for example, for the production of tickets or travel or transportation documents), devices of the so called “wet inlay” type, etc.

Such tags may be affixed to a wide variety of products and are suitable for many applications, including product or process tracking, storage and supply of pre and post-sales information, verification of product authenticity.

Satisfying these needs requires, in most cases, the writing of fixed and/or variable data to the memory of the chip residing within the RFID tag.

The continuous and progressive increase in market demand is hampered by the high costs both of the basic raw materials necessary for the production of RFID tags and the various conversion processes in order to arrive at the final product.

Continuous encoding processes are known (reading or writing information from and/or to RFID labels) that are routinely performed using production lines wherein a plurality of RFID tags is carried by a belt that presents such tags to one or more read/write devices (RFID R/RW encoding devices).

In order to ensure the writing of data to tag, the target of the specific encoding device only (avoiding the possibility of unintentionally writing to the previous or subsequent tag), the material is typically swiped on a metal screen that allows for radio shielding of those tags that are upstream and downstream of the one being processed.

This technological solution suffers from a physical productivity limitation that is linked to the maximum production speed compatible with the completion of the tag data writing process, a speed that is slower the more data there is to be written (and therefore the amount of time necessary for this to happen) to the memory of the chip.

By way of example, reported below is a table (Table 1) with some nominal reference values, wherein it is highlighted how, for the same amount of time required to transmit and store all the data on the individual tag, the travel speed of the conveyor belt (and, consequently, the process productivity) decreases with increasing pitch (the distance between tags along a longitudinal direction of the conveyor belt).

TABLE 1

| TAG Pitch | Operation time | Max speed | Productivity |
|---|---|---|---|
| (mm) | (ms) | (m/min) | (pcs/h) |
| 20 | 200 | 0.9 | 2700 |
| 50 | 200 | 1.5 | 1800 |

Also known are encoding processes based upon intermittent advancing (of the step-by-step type) of the conveyor belt, in order to position the tag(s) at the RFID reader(s) for the encoding operations.

With such a system, wherein the belt that conveys the tags has a discontinuous travel motion, said belt is stopped in such a way that the tag(s) to be encoded find themselves at the RFID reader(s).

Subsequently, the belt remains stopped for the amount of time necessary in order to complete the reading/writing operations, whereafter the belt is advanced by the pitch of the product (the linear distance between two successive tags) in such a way as to stop the subsequent tag at the RFID reader. The encoding sequence is then repeated.

Such a procedure, albeit in the face of an admissible travel speed (and therefore productivity) that is higher than that of the continuous motion cited above (as is evident from Table 2 below), has a significantly improved performance, as will be explained in more detail later in this description.

TABLE 2

| | | Number | Max | |
|---|---|---|---|---|
| TAG | Operation | of | equivalent | |
| Pitch | time | encoding | speed | Productivity |
| (mm) | (ms) | stations | (m/min) | (pcs/h) |
| 20 | 200 | 1 | 1.56 | 4700 |
| 50 | 200 | 1 | 2.74 | 3289 |
| 20 | 200 | 6 | 4.5 | 13600 |
| 50 | 200 | 6 | 7.52 | 9034 |

With the aim of further increasing productivity, an RFID tag encoding apparatus and process, according to the present invention provides, in view of a continuous conveyor belt feed, the presence of an auxiliary movement device that promotes the localised variation of the travel speed of such belt, in such a way as to cause an RFID tag to stop in front of an encoding device for the period of time necessary for the complete transmission of data from and to the tag.

In this way it becomes possible to increase the process productivity insofar as the tags are presented to the encoding device at best position for the transmission of data (condition of substantial alignment) for more time compared to a condition wherein the tag continues to slide past the encoding device, also with the same belt travel speed.

Likewise, the productivity is also increased compared to the case with an intermittent travel motion, insofar as the continuous pulling of the conveyor belt, when coupled to the auxiliary movement device and to the localised variation of the travel speed, makes it possible to significantly maximize the overall speed of the process, as may be appreciated from the following (Table 3), which shows the productivity of a process according to the present invention also with the same conditions as with the processes in the tables above.

TABLE 3

| TAG | Operation | Number of | | |
|---|---|---|---|---|
| Pitch | time | encoding | Max speed | Productivity |
| (mm) | (ms) | stations | (m/min) | (pcs/h) |
| 20 | 200 | 1 | 4.0 | 12000 |
| 50 | 200 | 1 | 10 | 12000 |
| 20 | 200 | 6 | 24.0 | 72000 |
| 50 | 200 | 6 | 60 | 72000 |
| 20 | 200 | 10 | 40.0 | 120000 |
| 50 | 200 | 10 | 100 | 120000 |

The aforesaid and other objects and advantages are achieved, according to an aspect of the invention, by an apparatus and a method for the encoding of RFID tags having the features defined in the appended claims.

### BRIEF DESCRIPTION OF THE DRAWINGS

The functional and structural features of some preferred embodiments of an apparatus and a method for the encoding of RFID tags according to the invention will now be described. Reference is made to the accompanying drawings, wherein:

FIGS. 1A and 1B are schematic diagrams of a series of RFID tags juxtaposed in a travel direction of a conveyor belt, according to two embodiments;

FIGS. 2A and 2B are schematic diagrams of an apparatus comprising, respectively, one and a plurality of RFID tag encoding stations, according to the prior art;

FIG. 3 is a schematic diagram of an RFID tag encoding apparatus, according to one embodiment of the present invention;

FIG. 4 is a schematic diagram of the apparatus of FIG. 3, under two operational conditions;

FIGS. 5A and 5B are outline schemes of two operational conditions of the apparatus according to the embodiment shown in FIGS. 3 and 4;

FIGS. 6A and 6B are outline schemes of two operational conditions of an apparatus according to an alternative embodiment;

FIGS. 7A and 7B are outline schemes of two operational conditions of the apparatus according to a further alternative embodiment;

FIGS. 8A and 8B are outline schemes of two operational conditions of the apparatus according to a further alternative embodiment; and

FIGS. 9A and 9B are outline schemes of two operational conditions of an apparatus according to a further alternative embodiment.

### DETAILED DESCRIPTION

Before explaining in detail a plurality of embodiments of the invention, it should be clarified that the invention is not limited in its application to the design details and configuration of the components presented in the following description or shown in the drawings. The invention may assume other embodiments and be implemented or constructed in practice in different ways. It should also be understood that the phraseology and terminology have a descriptive purpose and should not be construed as limiting.

Referring by way of example to the figures, an apparatus 9 for encoding RFID tags comprises at least one encoding means 10, suitable for receiving and/or transmitting signals from and/or to RFID tags carried by a belt B slidable in a travel direction. In this context, the travel direction is defined as such a sliding direction of the belt B (for example, a horizontal sliding direction) that the RFID tags may be presented to at least one encoding means 10 with an orientation that is suitable for permitting the reception and transmission of signals between the RFID tag T and the encoding means 10.

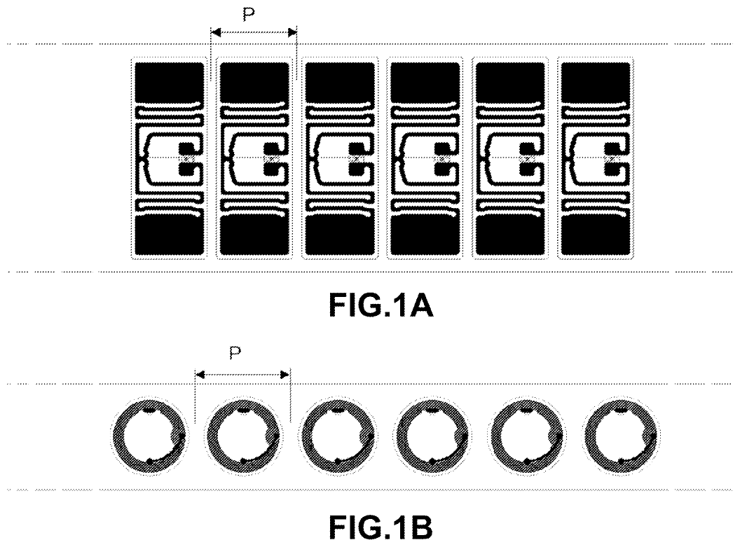

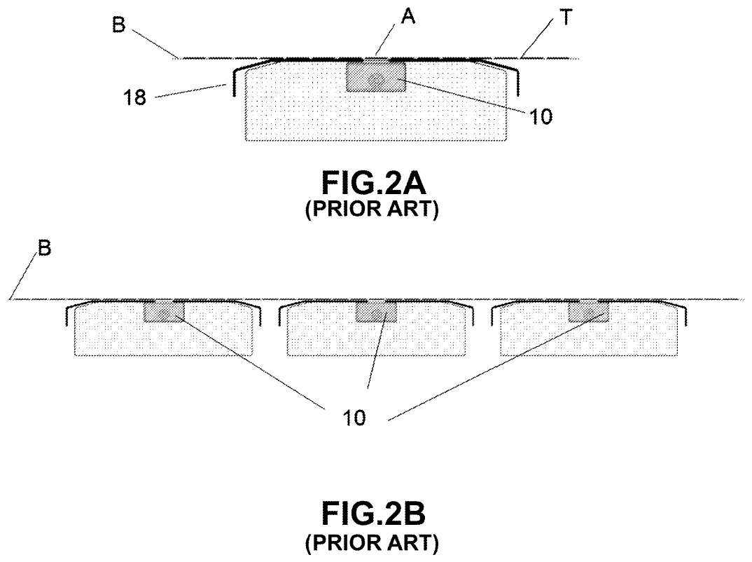

As shown by way of example in FIGS. 1A and 1B, the RFID tags may be conveniently juxta positioned, and spaced apart by a pitch P, along a longitudinal direction of the belt B.

The encoding means 10 is configured to read stored data and/or send data to be stored on an RFID tag, when the latter is within a transmission area A suitable for allowing the passage of radio frequency signals directed from the encoding means 10 to the RFID tag, and/or vice versa.

There are primary driving means 12, 13, adapted to pull the belt B, giving it a continuous forward motion at constant speed, and secondary driving means 14 for locally varying the speed of the belt B when an RFID tag is in proximity of a transmission area A, in such a way that said RFID tag T stops for a predetermined time within said transmission area A in absence of relative motion with respect to said encoding means 10, in the travel direction of the belt B, maintaining unchanged the travel speed of the belt B due to the pulling imparted by said primary driving means 12, 13, i.e., the travel speed of the belt B, respectively, upstream and downstream of the secondary driving means 14.

According to a preferred embodiment, the secondary driving means 14 intercept the belt B, respectively, upstream and downstream of the transmission area A and are movable in a coordinated manner therebetween, in such a way as to pull the belt B and temporarily extend the path thereof upstream of the transmission area A (and simultaneously shorten it downstream of such transmission area A), so as to cause the belt B to locally slow down up until an absence of motion condition between the RFID tag and the encoding means 10 at the transmission area A, and subsequently in such a way as to re-shorten the path of the belt B upstream of the transmission area A (and simultaneously lengthen it downstream of such transmission area A), thereby recuperating the initial configuration of the secondary driving means 14 so as to cause the belt B to locally accelerate until the RFID tag has completely exited the transmission area A.

Conveniently, the secondary driving means 14 may be configured in order to accelerate during a first step, pulling the belt B upstream of the transmission area A (for example lengthening the path of the belt B) and locally slowing down the belt B until an RFID tag T has completely entered a transmission area A; moving themselves at a constant speed, proportional to the travel speed of the belt B imparted by the pull exerted by the primary driving means 12, 13, so as to determine a relative absence of motion, for a predetermined time, between said RFID tag T and the corresponding encoding means 10 in the direction of the belt B; and again accelerating, pulling in the opposite direction compared to the first step, and locally accelerating the belt B until the RFID tag T has completely exited the transmission area A. In this way, the acceleration wherewith, during a first step, the secondary driving means 14 pull the belt B, gradually compensates for the global pulling of the belt B, wherein the speed thereof locally reduces so as to determine a relative absence of motion, for a predetermined time, between said RFID tag T and the corresponding encoding means 10 in the travel direction of the belt B; subsequently, the acceleration in the opposite direction compared to the first step, using the secondary driving means 14 pulling the belt B, will locally accelerate the belt B until the RFID tag T has completely exited the transmission area A.

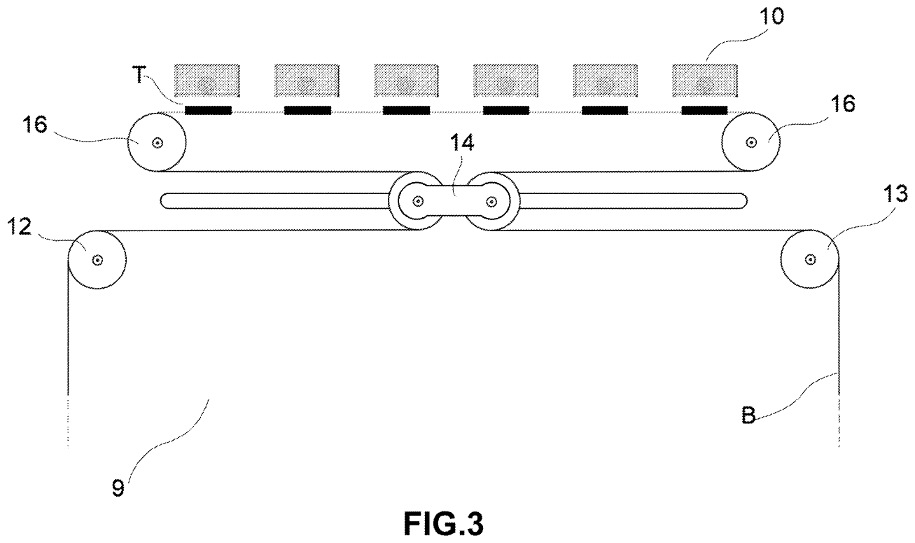

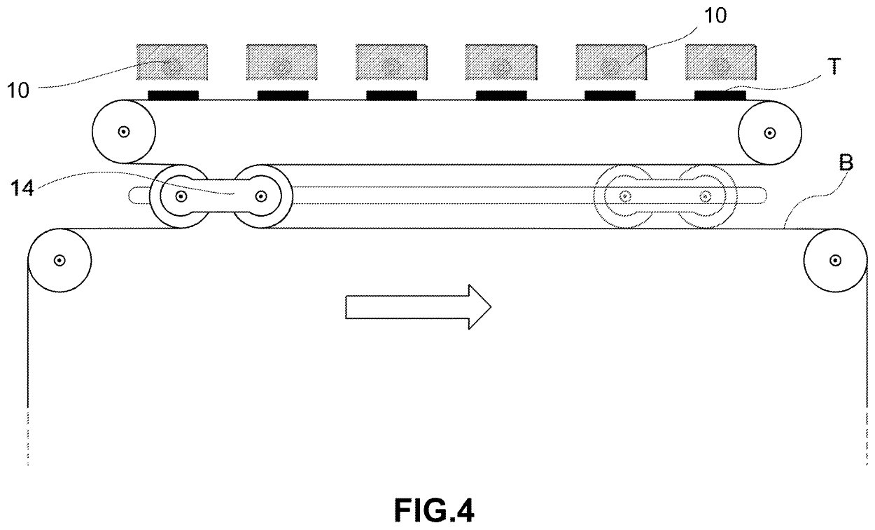

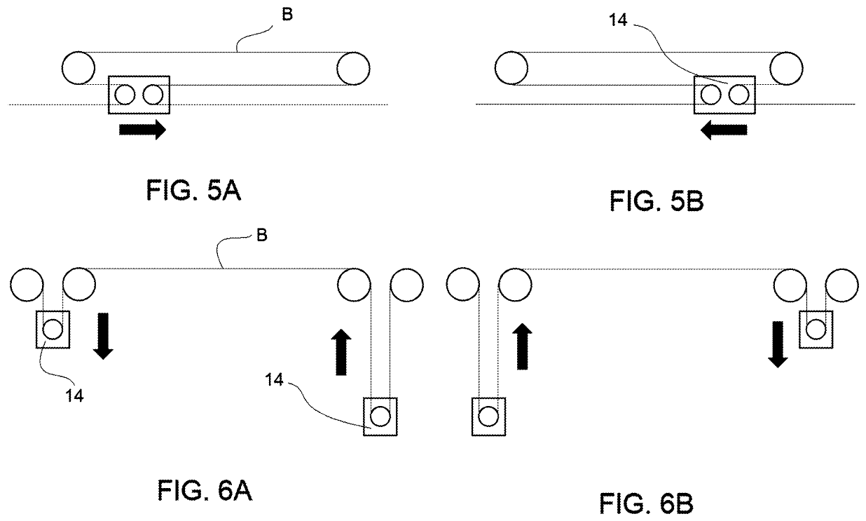

According to a preferred embodiment, shown schematically in FIGS. 3, 4, and 5A, 5B, the secondary driving means 14 comprise a slide equipped with a pair of secondary rollers capable of intercepting and guiding the belt B respectively upstream and downstream of a transmission area A. Such secondary rollers being movable by linear reciprocating motion integrally to the slide, along a direction parallel to the travel direction of the belt B.

According to an alternative embodiment, shown schematically in FIGS. 6A and 6B, the secondary driving means 14 comprise a pair of movable sliders moving in a reciprocating motion along directions substantially parallel therebetween and perpendicular to the direction of travel of the belt B, whereof a first slider is configured to intercept the belt B upstream of the transmission area A, and a second slider is configured to intercept the belt B downstream of the transmission area A. The first slider is configured to pull the belt B in the opposite direction in relation to the second slider, in such a way as to locally decelerate the belt B (when the trajectory of the latter is lengthened upstream of the transmission area A, and shortened downstream, as shown by way of example in FIG. 6B), until reaching a maximum extension, and substantially accelerating the belt B in order to cause the tag T to exit the transmission area A (when the trajectory of the latter is lengthened downstream of the transmission area A, and shortened upstream, as shown by way of example in FIG. 6A).

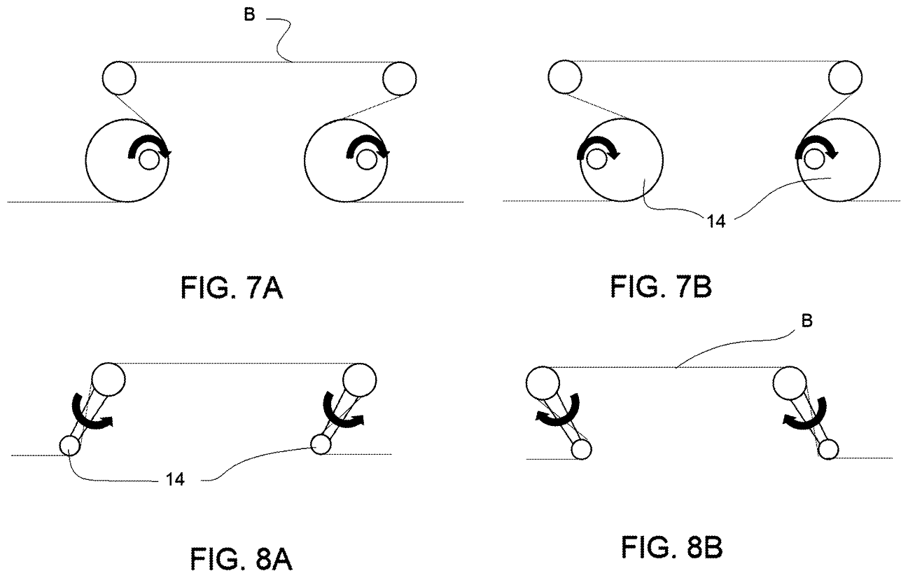

According to an alternative embodiment, shown schematically in FIGS. 7A and 7B, the secondary driving means 14 comprise a pair of cams revolving in an eccentric manner, wherein a first cam is configured to intercept the belt B upstream of the transmission area A, and a second cam is configured to intercept the belt B downstream of the transmission area A. The first cam is configured in such a way that, rotating to a first position, it lengthens the path of the belt B upstream of the transmission area A, locally decelerating the belt B (concomitant with a rotation of the second cam that shortens the downstream path thereof), as shown by way of example in FIG. 7B. Conversely, when the cams rotate in the configuration shown by way of example in FIG. 7A, the belt B is accelerated in order to cause the tag T to exit the transmission area A.

According to an alternative embodiment, shown schematically in FIGS. 8A and 8B, the secondary driving means 14 comprise a pair of oscillating bars, wherein a first bar is configured to intercept the belt B upstream of the transmission area A, and a second bar is configured to intercept the belt B downstream of the transmission area A. The first bar is configured in such a way that, rotating to a first position, it lengthens the path of the belt B upstream of the transmission area A, locally decelerating the belt B (concomitant with a rotation of the second bar that shortens the downstream path thereof), as shown by way of example in FIG. 8B. Conversely, when the bars rotate in the configuration shown by way of example in FIG. 8A, the belt B is accelerated in order to cause the tag T to exit the transmission area A.

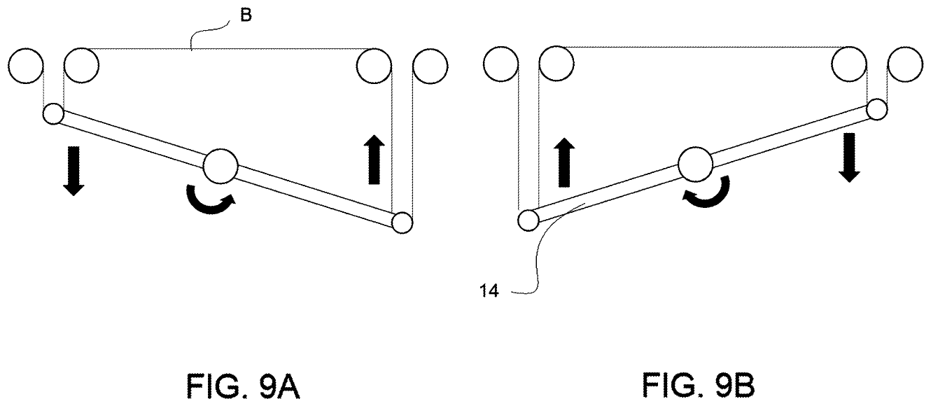

According to an alternative embodiment, shown schematically in FIGS. 9A and 9B, the secondary driving means 14 comprise a pair of oscillating rocker arms, having a first end configured to intercept the belt B upstream of the transmission area A, and a second end configured to intercept the belt B downstream of the transmission area A. The rocker arm is configured in such a way that, rotating to a first position, it lengthens the path of the belt B upstream of the transmission area A, locally decelerating the belt B (concomitant with a shortening of the downstream path thereof), as shown by way of example in FIG. 9B. Conversely, when the rocker arm rotates in the configuration shown by way of example in FIG. 9A, the belt B is accelerated in order to cause the tag T to exit the transmission area A.

The expressions “lengthen” or “shorten” the path of the belt B refer here to the action of pulling, on the part of the secondary driving means 14, the belt B, which modifies the path thereof in relation to the transmission area A, locally determining a temporary extension or contraction of the distance that the belt B has to travel in order to reach such transmission area A, insofar as a more or less pronounced loop is required, by complying with the pulling movement produced by the secondary driving means 14.

The primary driving means 12, 13 may furthermore comprise a first roller 12 and a second roller 13, arranged respectively upstream and downstream of the secondary driving means 14 with respect to the direction of travel of said belt B, and suitable for guiding and/or pulling said belt B in such a way that said belt B is movable in continuous motion, at a constant speed of travel, respectively upstream of said first roller 12 and downstream of said second roller 13.

A pair of deflection rollers 16 may be arranged upstream and downstream of the transmission area A with respect to the travel direction of the belt B. Such deflection rollers 16 are configured to intercept the belt B passing from the first roller 12 through the secondary driving means 14, deflecting said belt B along the travel direction in such a way that the RFID tags T pass through a transmission area A, and directing the belt B towards the second roller 13 through the secondary driving means 14.

The apparatus 9 may preferably comprise shielding means 18 interposed between the encoding means 10 and the respective transmission area A, which shielding means 18 being configured so as to delimit said transmission area A, preventing the transmission of a radio-frequency signal from the encoding means 10 towards the belt B in a neighborhood of the transmission area A. The shielding means 18 are therefore suitable for allowing the transmission of a signal from and or to an encoding means 10 only within the transmission area A, excluding those RFID tags that find themselves to be external thereto, in such a way as to only convey data to the RFID tag for which the data is intended and not those RFID tags that are immediately adjacent.

According to one embodiment, there is a plurality of encoding means 10 and respective transmission areas A spaced at a predetermined pitch along a travel direction of the belt B.

According to one aspect of the invention, an RFID tag encoding procedure comprises the steps of providing an encoding apparatus 9 according to any one of the embodiments described above; by means of the primary driving means 12, 13, continuously feeding the belt B at a constant speed along a travel direction, so as to convey the RFID tags T to at least one transmission area A; while keeping the drive imparted by the primary driving means 12, 13 to the belt B unchanged, varying the travel speed of the belt B in a periodic and localised manner so that an RFID tag T stops for a predetermined time within said transmission area A, in the absence of relative motion with respect to the corresponding encoding means 10 in the travel direction of the belt B; and activating said encoding means 10 in such a way as to receive and/or transmit signals from and/or to said RFID tag T, until said RFID tag T has received, transmitted and/or stored all data intended to be exchanged with said encoding means 10.

According to a preferred embodiment, the step of varying the travel speed of the belt B in a periodic and localised manner is actuated by means of the step of translating the secondary driving means 14 with accelerated linear motion, in a direction concurrent with the travel direction of belt B, locally slowing down the belt B until an RFID tag T has completely entered a transmission area A; stopping, or translating the secondary driving means 14 with linear motion at a constant speed, proportional to the travel speed of the belt B imparted by the pull exerted by the primary driving means 12, 13, so as to determine a relative absence of motion, for a predetermined time, between said RFID tag T and the corresponding encoding means 10 in the travel direction of the belt B; and translating the secondary driving means 14 with accelerated linear motion, in the direction opposite to the travel direction of the belt B, locally accelerating the belt B until the RFID tag T has completely exited the transmission area A.

Similarly, according to alternative embodiments of the invention, it is possible to cause the secondary driving means 14 to oscillate or rotate with an accelerated circular motion in a first direction of rotation, in such a way as to locally slow down the belt B until an RFID tag T has completely entered a transmission area A; stopping, or causing the secondary driving means 14 to oscillate or rotate with a circular motion at a constant speed, proportional to the travel speed of the belt B imparted by the pull exerted by the primary driving means 12, 13, so as to determine a relative absence of motion, for a predetermined time, between said RFID tag T and the corresponding encoding means 10 in the travel direction of the belt B; and causing the secondary driving means 14 to oscillate or rotate with an accelerated circular motion in a second direction of rotation, opposite the first, in such a way as to locally accelerate the belt B until the RFID tag T has completely exited the transmission area A. Such actuation method may, for example, be applied to the configuration shown by way of example in FIGS. 7A and 7B, wherein the cams are first made to rotate (passing substantially from the configuration in FIG. 7A to that in FIG. 7B, in such a way as to locally slow down the belt B until an RFID tag T has completely entered the transmission area A), and subsequently in the opposite direction (passing substantially from the configuration in FIG. 7B to that in FIG. 7A, in such a way as to locally accelerate the belt B until the RFID tag T has completely exited the transmission area A). Similarly, the configuration shown by way of example in FIGS. 8A and 8B may be actuated in making the bars oscillate firstly in one direction (passing substantially from the configuration in FIG. 8A to that in FIG. 8B, in such a way as to locally slow down the belt B until an RFID tag T has completely entered the transmission area A), and subsequently in the opposite direction (passing substantially from the configuration in FIG. 8B to that in FIG. 8A, in such a way as to locally accelerate the belt B until the RFID tag T has completely exited the transmission area A). Again, the configuration shown by way of example in FIGS. 9A and 9B may be actuated in making the bars oscillate, firstly in one direction (passing substantially from the configuration in FIG. 9A to that in FIG. 9B, in such a way as to locally slow down the belt B until an RFID tag T has completely entered the transmission area A), and subsequently in the opposite direction (passing substantially from the configuration in FIG. 9B to that in FIG. 9A, in such a way as to locally accelerate the belt B until the RFID tag T has completely exited the transmission area A).

According to a preferred embodiment, the step of encoding the last RFID tag T is followed by the step of causing the belt B to advance by an amount equal to the distance between the last RFID tag T having received, transmitted and/or stored all the data intended to be exchanged with the encoding means 10, and the first of the subsequent RFID tags (in relation to the travel direction of the belt B) having yet to receive, transmit and/or store all the data intended to be exchanged with the encoding means 10, in such a way as to position this last RFID tag at a transmission area A in order to proceed with a new encoding. Such displacement may amount, when, for example, there is only one encoding means 10, to the pitch P between two successive RFID tags.

Various aspects and embodiments of an apparatus and a method for the encoding of RFID tags according to the invention have been described. It is understood that each embodiment may be combined with any other embodiment. Moreover, the invention is not limited to the embodiments described, but may be varied within the scope defined by the appended claims.

1. An apparatus for encoding radio-frequency identification (RFID) tags, comprising:
at least one encoding device configured for receiving or transmitting signals from or to RFID tags carried by a belt slidable in a travel direction, the encoding device being configured to read stored data or send data to be stored on an RFID tag when the RFID tag is within a transmission area suitable for allowing the passage of radio frequency signals directed from the at least one encoding device to or from the RFID tag;
primary driving means adapted to pull the belt giving the belt a continuous forward motion at constant speed; and
secondary driving means that vary the speed of the belt when the RFID tag is in a proximity of the transmission area, in such a way that the RFID tag stops for a predetermined time within the transmission area in absence of relative motion with respect to the encoding device, in the travel direction of the belt, maintaining unchanged the travel speed of the belt due to the pulling imparted by the primary driving means.

2. The apparatus according to claim 1, wherein the secondary driving means comprise a slide equipped with a pair of secondary rollers capable of intercepting and guiding the belt respectively upstream and downstream of a transmission area, the secondary rollers being movable by linear reciprocating motion integrally to the slide, along a direction parallel to the travel direction of the belt.

3. The apparatus according to claim 2, wherein the primary driving means comprise a first roller and a second roller, arranged respectively upstream and downstream of the secondary driving means with respect to the direction of travel of the belt, and suitable for guiding or pulling the belt in such a way that the belt is movable in continuous motion, at a constant speed of travel, respectively upstream of the first roller and downstream of the second roller.

4. The apparatus according to claim 3, comprising a pair of deflection rollers arranged upstream and downstream of the transmission area with respect to the travel direction of the belt advancement, the deflection rollers being configured to intercept the belt passing from the first roller through the secondary driving means, deflecting the belt along the travel direction in such a way that the RFID tags pass through a transmission area, and directing the belt towards the second roller through the secondary driving means.

5. The apparatus according to claim 1, wherein the secondary driving means comprise a pair of movable sliders moving in a reciprocating motion along directions substantially parallel therebetween and perpendicular to the direction of travel of the belt, whereof a first slider is configured to intercept the belt upstream of the transmission area, and a second slider is configured to intercept the belt downstream of the transmission area.

6. The apparatus according to claim 1, wherein the secondary driving means comprise a pair of cams pivotable in an eccentric manner, wherein a first cam is configured to intercept the belt upstream of the transmission area, and a second cam is configured to intercept the belt downstream of the transmission area.

7. The apparatus according to claim 1, wherein the secondary driving means comprise a pair of oscillating bars, wherein a first bar is configured to intercept the belt upstream of the transmission area, and a second bar is configured to intercept the belt downstream of the transmission area.

8. The apparatus according to claim 1, wherein the secondary driving means comprise a pair of oscillating rocker arms, having a first end configured to intercept the belt upstream of the transmission area, and a second end configured to intercept the belt downstream of the transmission area.

9. The apparatus according to claim 1, comprising shielding means interposed between the encoding device and the respective transmission area, the shielding means being configured so as to delimit the transmission area, preventing transmission of a radio-frequency signal from the encoding device towards the belt in a neighborhood of the transmission area.

10. The apparatus according to claim 1, comprising a plurality of encoding device media and respective transmission areas spaced at a predetermined pitch along the travel direction of the belt.

11. A process for encoding radio-frequency identification (RFID) tags comprising:
a) providing an encoding apparatus including at least one encoding device configured for receiving or transmitting signals from or to RFID tags carried by a belt slidable in a travel direction, primary driving means adapted to pull the belt in a continuous forward motion at constant speed, and secondary driving means that vary the speed of the belt when the RFID tag is in a proximity of the transmission area;
b) by means of the primary driving means, continuously feeding the belt at a constant speed along a travel direction, so as to convey the RFID tags to at least one transmission area;
c) while keeping the drive imparted by the primary driving means to the belt unchanged, varying the travel speed of the belt in a periodic and localized manner so that an RFID tag stops for a predetermined time within the transmission area, in the absence of relative motion with respect to the corresponding encoding device in the travel direction of the belt; and
d) activating the encoding device in such a way as to receive or transmit signals from or to the RFID tag, until the RFID tag has received, transmitted or stored data intended to be exchanged with the encoding device.

12. The process according to claim 11, wherein step c) is carried out by:
c1) translating the secondary driving means with accelerated linear motion, in a direction concurrent with the travel direction of belt, locally slowing down the belt until the RFID tag has entered a transmission area;
c2) stopping, or translating the secondary driving means with linear motion at a constant speed, proportional to the travel speed of the belt imparted by a pull exerted by the primary driving means, so as to determine a relative absence of motion, for a predetermined time, between the RFID tag and the corresponding encoding device in the travel direction of the belt; and
c3) translating the secondary driving means with accelerated linear motion, in a direction opposite to the travel direction of the belt, locally accelerating the belt until the RFID tag has exited the transmission area.

13. The process according to claim 11, wherein step c) is actuated by:
c4) causing the secondary driving means to oscillate or rotate with an accelerated circular motion in a first direction of rotation, in such a way as to locally slow down the belt until an RFID tag has entered a transmission area;
c5) stopping, or making the secondary driving means oscillate or rotate with a circular motion at a constant speed, proportional to the travel speed of the belt imparted by the pull exerted by the primary driving means, so as to determine a relative absence of motion, for a predetermined time, between the RFID tag and the corresponding encoding device in the travel direction of the belt; and
c6) causing the secondary driving means to oscillate or rotate with an accelerated circular motion in a second direction of rotation, opposite the first, in such a way as to locally accelerate the belt until the RFID tag has exited the transmission area.

14. The process Process-according to claim 11, wherein step d) is followed by a step of advancing the belt by an amount equal to the distance between last RFID tag having received, transmitted or stored the data intended to be exchanged with the encoding device, and a first of subsequent RFID tags having yet to receive, transmit or store the data intended to be exchanged with the encoding device.
